(19) United States
(12) Patent Application Publication
(10) Pub. No.: US 2026/0133875 A1
(43) Pub. Date: May 14, 2026

(54) ERROR HANDLING METHOD, MEMORY STORAGE DEVICE AND MEMORY CONTROL CIRCUIT UNIT

(71) Applicant: PHISON ELECTRONICS CORP., Miaoli (TW)

(72) Inventors: Shih-Jia Zeng, Hsinchu City (TW); Chun-Ching Li, Miaoli County (TW); Kuan-Chou Lin, Hsinchu County (TW); Hsiao-Yi Lin, Yilan County (TW); Yi-Fang Chang, Miaoli County (TW)

(73) Assignee: PHISON ELECTRONICS CORP., Miaoli (TW)

(21) Appl. No.: 19/007,606

(22) Filed: Jan. 2, 2025

(30) Foreign Application Priority Data
Nov. 14, 2024 (TW) 113143850

(51) Int. Cl. G06F 11/10

(52) U.S. Cl. CPC G06F 11/1048

(57) ABSTRACT

An error handling method, a memory storage device, and a memory control circuit unit are provided. The error handling method includes: calculating a first decoding rate of a first error handling process, where the first error handling process includes a plurality of decoding operations performed based on a first order; and in response to the first decoding rate being less than a first threshold, switching the first error handling process to a second error handling process, where the second error handling process includes a plurality of decoding operations performed based on a second order, where a decoding capability of a first decoding operation indicated by the second order is better than a decoding capability of a first decoding operation indicated by the first order.

### CROSS-REFERENCE TO RELATED APPLICATION

This application claims the priority benefit of Taiwan application serial no. 113143850, filed on Nov. 14, 2024. The entirety of the above-mentioned patent application is hereby incorporated by reference herein and made a part of this specification.

### BACKGROUND

### Technical Field

The disclosure relates to a memory management technology, and in particular, relates to an error handling method, a memory storage device, and a memory control circuit unit.

Description of Related Art

In recent years, the rapid growth of portable electronic devices such as mobile phones and laptops has led to a sharp increase in consumer demand for storage media. Rewritable non-volatile memory modules (e.g., flash memory) have the characteristics of non-volatility, power saving, compact sizes, and absence of mechanical structures, so they are suitable for being built into the various portable electronic devices mentioned above.

When the read data cannot be corrected, the memory storage device is able to perform an error handling process accordingly. In a normal error handling process, the memory storage device performs the decoding operation that takes the least time first. If the decoding fails, the memory storage device sequentially performs a decoding operation that takes longer and has a stronger decoding capability. When the number of error bits of the rewritable non-volatile memory module is not high, the initial decoding operation with the shortest operation time is able to successfully decode most of the data. However, when the number of error bits of the rewritable non-volatile memory module becomes high, most of the data can only be successfully decoded in a subsequent decoding operation with stronger decoding capability. In this case, the conventional error handling process will result in a longer average decoding time, which would degrade the performance of the memory storage device.

### SUMMARY

The disclosure provides an error handling method, a memory storage device, and a memory control circuit unit capable of selecting different error handling processes according to actual conditions to reduce time costs and improve the performance of the memory storage device.

An exemplary embodiment of the disclosure provides an error handling method for a rewritable non-volatile memory module, and the error handling method includes the following steps. A first decoding rate of a first error handling process is calculated. The first error handling process includes a plurality of decoding operations performed based on a first order. In response to the first decoding rate being less than a first threshold, the first error handling process is switched to a second error handling process. The second error handling process includes a plurality of decoding operations performed based on a second order. A decoding capability of a first decoding operation indicated by the second order is better than a decoding capability of a first decoding operation indicated by the first order.

In an exemplary embodiment, the error handling method further includes the following steps. A second decoding rate of the second error handling process is calculated. In response to the second decoding rate being not less than a second threshold, the second error handling process is switched to the first error handling process.

In an exemplary embodiment of the disclosure, the first decoding rate is a success rate of the first decoding operation indicated by the first order.

In an exemplary embodiment of the disclosure, the second decoding rate is a success rate of each of the decoding operations in the second error handling process.

In an exemplary embodiment of the disclosure, the first error handling process includes a first number of decoding operations, and the second error handling process includes a second number of decoding operations. The first number is greater than the second number.

In an exemplary embodiment, the error handling method further includes the following steps. Health status information of the rewritable non-volatile memory module is obtained. According to the health status information, one of the first error handling process, the second error handling process, and a third error handling process is adopted.

In an exemplary embodiment of the disclosure, the third error handling process includes a plurality of decoding operations performed based on a third order. A decoding capability of a first decoding operation indicated by the third order is better than the decoding capability of the first decoding operation indicated by the second order.

An exemplary embodiment of the disclosure further provides a memory storage device including a connection interface unit, a rewritable non-volatile memory module, and a memory control circuit unit. The connection interface unit is configured to be coupled to a host system. The memory control circuit unit is coupled to the connection interface unit and the rewritable non-volatile memory module. The memory control circuit unit is configured to calculate a first decoding rate of a first error handling process. The first error handling process includes a plurality of decoding operations performed based on a first order. In response to the first decoding rate being less than a first threshold, the memory control circuit unit is further configured to switch the first error handling process to a second error handling process. The second error handling process includes a plurality of decoding operations performed based on a second order. A decoding capability of a first decoding operation indicated by the second order is better than a decoding capability of a first decoding operation indicated by the first order.

In an exemplary embodiment of the disclosure, the memory control circuit unit is further configured to calculate a second decoding rate of the second error handling process. In response to the second decoding rate being not less than a second threshold, the memory control circuit unit is further configured to switch the second error handling process to the first error handling process.

In an exemplary embodiment of the disclosure, the memory control circuit unit is further configured to obtain health status information of the rewritable non-volatile memory module. The memory control circuit unit is further configured to according to the health status information, adopt one of the first error handling process, the second error handling process, and a third error handling process.

An exemplary embodiment of the disclosure further provides a memory control circuit unit configured for controlling a rewritable non-volatile memory module. The memory control circuit unit includes a host interface, a memory interface, and a memory management circuit. The host interface is configured to be coupled to a host system. The memory interface is configured to be coupled to the rewritable non-volatile memory module. The memory management circuit is coupled to the host interface and the memory interface. The memory management circuit is configured to calculate a first decoding rate of a first error handling process. The first error handling process includes a plurality of decoding operations performed based on a first order. In response to the first decoding rate being less than a first threshold, the memory management circuit is further configured to switch the first error handling process to a second error handling process. The second error handling process includes a plurality of decoding operations performed based on a second order. A decoding capability of a first decoding operation indicated by the second order is better than a decoding capability of a first decoding operation indicated by the first order.

In an exemplary embodiment of the disclosure, the memory management circuit is further configured to calculate a second decoding rate of the second error handling process. In response to the second decoding rate being not less than a second threshold, the memory management circuit is further configured to switch the second error handling process to the first error handling process.

In an exemplary embodiment of the disclosure, the memory management circuit is further configured to obtain health status information of the rewritable non-volatile memory module. The memory management circuit is further configured to, according to the health status information, adopt one of the first error handling process, the second error handling process, and a third error handling process.

An exemplary embodiment of the disclosure further provides a memory storage device including a connection interface unit, a rewritable non-volatile memory module, and a memory control circuit unit. The connection interface unit is configured to be coupled to a host system. The memory control circuit unit is coupled to the connection interface unit and the rewritable non-volatile memory module. The memory control circuit unit is configured to perform a first error handling process or a second error handling process. The first error handling process includes a plurality of decoding operations performed based on a first order, and the first error handling process includes a first number of decoding operations. The second error handling process includes a plurality of decoding operations performed based on a second order, and the second error handling process includes a second number of decoding operations. At least one decoding operation among the decoding operations included in the first error handling process is the same as at least one decoding operation among the decoding operations included in the second error handling process. A decoding capability of a first decoding operation indicated by the second order is better than a decoding capability of a first decoding operation indicated by the first order. The first number is greater than the second number.

In an exemplary embodiment of the disclosure, the memory control circuit unit is further configured to perform one of the first error handling process, the second error handling process, and a third error handling process. The third error handling process includes a plurality of decoding operations performed based on a third order. A decoding capability of a first decoding operation indicated by the third order is better than the decoding capability of the first decoding operation indicated by the second order.

In an exemplary embodiment of the disclosure, the at least one decoding operation among the decoding operations included in the first error handling process, the as at least one decoding operation among the decoding operations included in the second error handling process, and at least one decoding operation among the decoding operations included in the third error handling process are the same.

An exemplary embodiment of the disclosure further provides a memory control circuit unit configured for controlling a rewritable non-volatile memory module. The memory control circuit unit includes a host interface, a memory interface, and a memory management circuit. The host interface is configured to be coupled to a host system. The memory interface is configured to be coupled to the rewritable non-volatile memory module. The memory management circuit is coupled to the host interface and the memory interface. The memory management circuit is configured to perform a first error handling process or a second error handling process. The first error handling process includes a plurality of decoding operations performed based on a first order, and the first error handling process includes a first number of decoding operations. The second error handling process includes a plurality of decoding operations performed based on a second order, and the second error handling process includes a second number of decoding operations. At least one decoding operation among the decoding operations included in the first error handling process is the same as at least one decoding operation among the decoding operations included in the second error handling process. A decoding capability of a first decoding operation indicated by the second order is better than a decoding capability of a first decoding operation indicated by the first order. The first number is greater than the second number.

In an exemplary embodiment of the disclosure, the memory management circuit is further configured to perform one of the first error handling process, the second error handling process, and a third error handling process. The third error handling process includes a plurality of decoding operations performed based on a third order. A decoding capability of a first decoding operation indicated by the third order is better than the decoding capability of the first decoding operation indicated by the second order.

To sum up, in the error handling method, the memory storage device, and the memory control circuit unit, an appropriate error handling process is selected based on the decoding rate of the current error handling process or the health status information of the rewritable non-volatile memory module. In this way, the decoding time is reduced, and the performance of the memory storage device is improved.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view illustrating a host system, a memory storage device, and an input/output (I/O) device according to an exemplary embodiment of the disclosure.

FIG. 2 is a schematic view illustrating the host system, the memory storage device, and the I/O device according to an exemplary embodiment of the disclosure.

FIG. 3 is a schematic view illustrating the host system and the memory storage device according to an exemplary embodiment of the disclosure.

FIG. 4 is a schematic block view illustrating the memory storage device according to an exemplary embodiment of the disclosure.

FIG. 5 is a schematic block view illustrating a memory control circuit unit according to an exemplary embodiment of the disclosure.

FIG. 6 is a schematic view illustrating management of a rewritable non-volatile memory module according to an exemplary embodiment of the disclosure.

FIG. 7 is a schematic view illustrating different types of error handling processes according to an exemplary embodiment of the disclosure.

FIG. 8 is a flow chart illustrating an error handling method according to an exemplary embodiment of the disclosure.

FIG. 9 is a flow chart illustrating an error handling method according to an exemplary embodiment of the disclosure.

FIG. 10 is a flow chart illustrating an error handling method according to an exemplary embodiment of the disclosure.

### DESCRIPTION OF THE EMBODIMENTS

Generally, a memory storage device (aka a memory storage system) includes a rewritable non-volatile memory module and a controller (aka a control circuit). The memory storage device may be used together with a host system, so that the host system may write data into the memory storage device or may read data from the memory storage device.

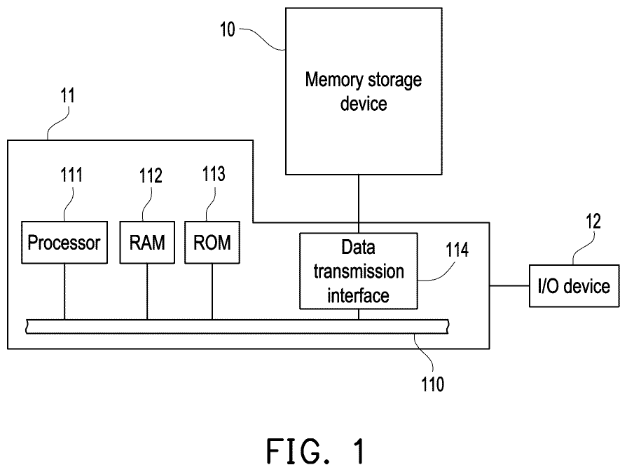

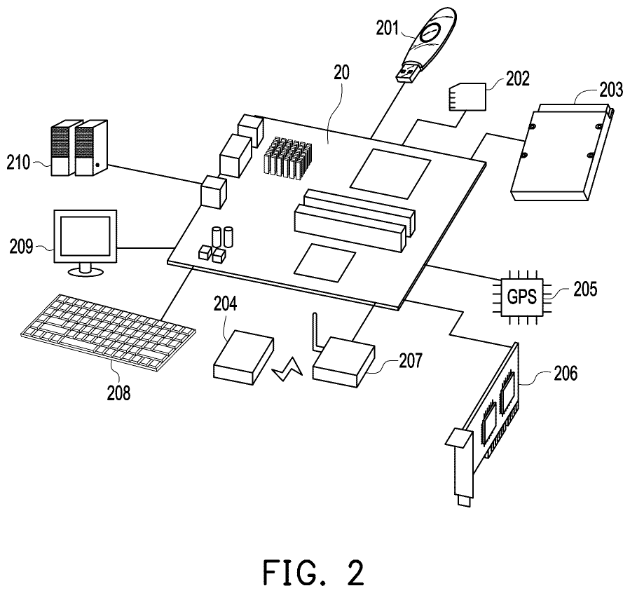

FIG. 1 is a schematic view illustrating a host system, a memory storage device, and an input/output (I/O) device according to an exemplary embodiment of the disclosure. FIG. 2 is a schematic view illustrating the host system, the memory storage device, and the I/O device according to an exemplary embodiment of the disclosure.

With reference to FIG. 1 and FIG. 2, a host system 11 may include a processor 111, a random access memory (RAM) 112, a read only memory (ROM) 113, and a data transmission interface 114. The processor 111, the random access memory 112, the read only memory 113, and the data transmission interface 114 may be coupled to a system bus 110.

In an exemplary embodiment, the host system 11 may be coupled to a memory storage device 10 through the data transmission interface 114. For instance, the host system 11 may store data into the memory storage device 10 or may read data from the memory storage device 10 through the data transmission interface 114. Further, the host system 111 may be coupled to an I/O device 12 through the system bus 110. For instance, the host system 11 may transmit an output signal to the I/O device 12 or receive an input signal from the I/O device 12 through the system bus 110.

In an exemplary embodiment, the processor 111, the random access memory 112, the read only memory 113, and the data transmission interface 114 may be disposed on a motherboard 20 of the host system 11. The number of the data transmission interface 114 may be one or plural. Through the data transmission interface 114, the motherboard 20 may be coupled to the memory storage device 10 through wired or wireless methods.

In an exemplary embodiment, the memory storage device 10 may be, for example, a flash drive 201, a memory card 202, a solid state drive (SSD) 203, or a wireless memory storage device 204. The wireless memory storage device 204 may be, for example, a memory storage device based on various wireless communication technologies, such as a near field communication (NFC) memory storage device, a wireless fidelity (WiFi) memory storage device, a Bluetooth memory storage device, or a low energy Bluetooth memory storage device (e.g., iBeacon). Besides, the motherboard 20 may also be coupled to various I/O devices including a global positioning system (GPS) module 205, a network interface card 206, a wireless transmission device 207, a keyboard 208, a monitor 209, and a speaker 210 through the system bus 110. For instance, in an exemplary embodiment, the motherboard 20 may access the wireless memory storage device 204 through the wireless transmission device 207.

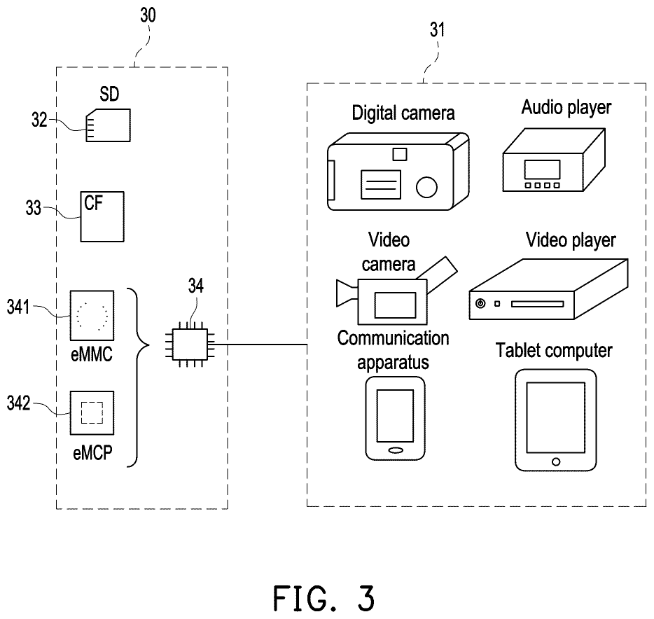

In an exemplary embodiment, the host system 11 may be a computer system. In an exemplary embodiment, the host system 11 may be any system capable of substantially cooperating with the memory storage device for storing data. In an exemplary embodiment, the memory storage device 10 and the host system 11 may include a memory storage device 30 and a host system 31 of FIG. 3 respectively.

FIG. 3 is a schematic view illustrating the host system and the memory storage device according to an exemplary embodiment of the disclosure. With reference to FIG. 3, the memory storage device 30 may be used together with the host system 31 to store data. For instance, the host system 31 may be a system such as a digital camera, a video camera, a communication apparatus, an audio player, a video player, or a tablet computer. For instance, the memory storage device 30 may be a non-volatile memory storage device used by the host system 31, such as a secure digital (SD) card 32, a compact flash (CF) card 33, or an embedded storage device 34. The embedded storage device 34 includes various embedded storage devices capable of directly coupling a memory module onto a substrate of the host system, such as an embedded Multi Media Card (eMMC) 341 and/or an embedded Multi Chip Package (eMCP) storage device 342.

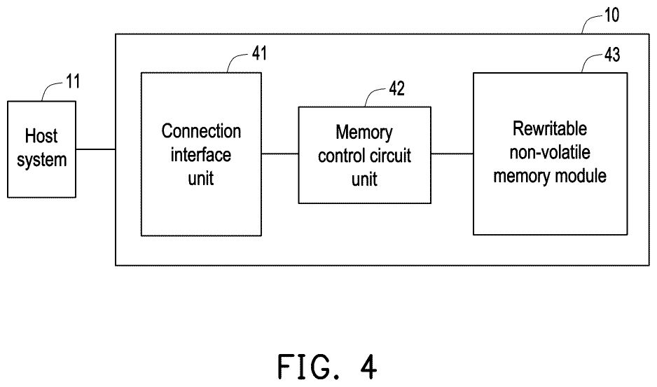

FIG. 4 is a schematic block view illustrating the memory storage device according to an exemplary embodiment of the disclosure. With reference to FIG. 4, the memory storage device 10 includes a connection interface unit 41, a memory control circuit unit 42, and a rewritable non-volatile memory module 43.

The connection interface unit 41 is configured to be coupled to the host system 11. The memory storage device 10 may communicate with the host system 11 through the connection interface unit 41. In an exemplary embodiment, the connection interface unit 41 is compatible with the peripheral component interconnect express (PCI Express) standard. In an exemplary embodiment, the connection interface unit 41 may also comply with the Serial Advanced Technology Attachment (SATA) standard, the Parallel Advanced Technology Attachment (PATA) standard, the Institute of Electrical and Electronic Engineers (IEEE) 1394 standard, the Universal Serial Bus (USB) standard, the Secure Digital (SD) interface standard, the Ultra High Speed-I (UHS-I) interface standard, the Ultra High Speed-II (UHS-II) interface standard, the Memory Stick (MS) interface standard, the Multi Chip Package (MCP) interface standard, the Multi Media Card (MMC) interface standard, the embedded Multi Media Card (eMMC) interface standard, the Universal Flash Storage (UFS) interface standard, the embedded Multi Chip Package (eMCP) interface standard, the Compact Flash (CF) interface standard, the Integrated Device Electronics (IDE) interface standard, or other applicable standards. The connection interface unit 41 may be packaged in a chip together with the memory control circuit unit 42, or the connection interface unit 41 may be disposed outside a chip including the memory control circuit unit 42.

The memory control circuit unit 42 is coupled to the connection interface unit 41 and the rewritable non-volatile memory module 43. The memory control circuit unit 42 is configured to execute a plurality of logic gates or control commands which are implemented in a form of hardware or firmware and to execute operations of data writing, reading, or erasing in the rewritable non-volatile memory module 43 according to the commands of the host system 11.

The rewritable non-volatile memory module 43 is configured to store data written by the host system 11. The rewritable non-volatile memory module 43 may include a single level cell (SLC) NAND flash memory module (i.e., a flash memory module capable of storing 1 bit in one memory cell), a multi level cell (MLC) NAND flash memory module (i.e., a flash memory module capable of storing 2 bits in one memory cell), a triple level cell (TLC) NAND flash memory module (i.e., a flash memory module capable of storing 3 bits in one memory cell), a quad level cell (QLC) NAND flash memory module (i.e., a flash memory module capable of storing 4 bits in one memory cell), other flash memory modules, or any memory module having the same features.

Each memory cell in the rewritable non-volatile memory module 43 stores one bit or more bits with a change in voltage (referred to as “threshold voltage” hereinafter). Specifically, a charge trapping layer is provided between a control gate of each memory cell and a channel. By applying a write voltage to the control gate, the amount of electrons of the charge trapping layer may be changed, and the threshold voltage of the memory cell is thereby changed. The operation of changing the threshold voltage of the memory cell is also called as “writing data to the memory cell” or “programming the memory cell”. Each memory cell in the rewritable non-volatile memory module 43 has a plurality of storage states according to the change of the threshold voltage. The storage state of the memory cell may be determined by applying a reading voltage, and the one or more bits stored in the memory cell is thereby obtained.

In an exemplary embodiment, the memory cells of the rewritable non-volatile memory module 43 may form a plurality of physical programming units, and the physical programming units may form a plurality of physical erasing units. Specifically, the memory cells on the same word line may form one physical programming unit or a plurality of physical programming units. If each of the memory cells stores 2 bits or more bits, the physical programming units on the same word line may at least be categorized as a lower physical programming unit and an upper physical programming unit. For instance, a least significant bit (LSB) of one memory cell belongs to the lower physical programming unit, and a most significant bit (MSB) of one memory cell belongs to the upper physical programming unit. Generally, in an MLC NAND flash memory module, the writing speed of the lower physical programming unit may be greater than the writing speed of the upper physical programming unit, and/or the reliability of the lower physical programming unit is greater than the reliability of the upper physical programming unit.

In an exemplary embodiment, the physical programming units are the smallest units for programming. That is, the physical programming units are the minimum units for writing data. For example, the physical programming units may be physical pages or physical sectors. When the physical programming units are the physical pages, these physical programming units may include a data bit region and a redundancy bit region. The data bit region includes a plurality of physical sectors for storing user data, and the redundancy bit region is configured for storing system data (e.g., management data such as an error correcting code). In an exemplary embodiment, the data bit region includes 32 physical sectors, and a size of each of the physical sectors is 512 bytes (B). However, in other exemplary embodiments, the data bit region may include 8, 16, or more or fewer physical sectors. The size of each of the physical sectors may be greater or smaller. On the other hand, the physical erasing units are the minimum units for erasing. That is, each of the physical erasing units contains the least number of memory cells to be erased together. The physical erasing units are physical blocks, for example.

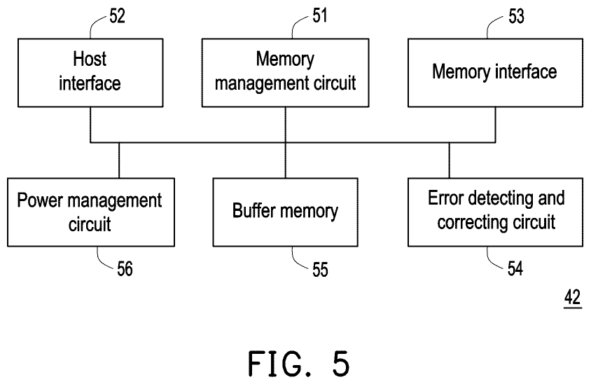

FIG. 5 is a schematic block view illustrating a memory control circuit unit according to an exemplary embodiment of the disclosure. With reference to FIG. 5, the memory control circuit unit 42 includes a memory management circuit 51, a host interface 52, and a memory interface 53.

The memory management circuit 51 is configured to control the overall operation of the memory control circuit unit 42. Specifically, the memory management circuit 51 has a plurality of control commands. When the memory storage device 10 runs, these control commands are executed to perform various operations such as data writing, data reading, and data erasing. The following description of the operation of the memory management circuit 51 is equivalent to the description of the operation of the memory control circuit unit 42.

In an exemplary embodiment, the control commands of the memory management circuit 51 are implemented in a form of firmware. For instance, the memory management circuit 51 has a microprocessor unit (not shown) and a read-only memory (not shown), and these control commands are burnt into the read-only memory. When the memory storage device 10 works, the control commands are executed by the microprocessor unit for performing various operations, such as data writing, data reading, and data erasing.

In an exemplary embodiment, the control commands of the memory management circuit 51 may also be stored in a specific region (for example, a system region in the memory module exclusively used for storing system data) of the rewritable non-volatile memory module 43 in the form of program codes. Moreover, the memory management circuit 51 has a microprocessor unit (not shown), a read-only memory (not shown), and a random access memory (not shown). In particular, this read-only memory has a boot code, and when the memory control circuit unit 42 is enabled, the boot code is executed by the microprocessor unit first for loading the control commands stored in the rewritable non-volatile memory module 43 to the random access memory of the memory management circuit 51. Afterwards, the microprocessor unit executes these control commands for various operations such as data writing, data reading, and data erasing.

In an exemplary embodiment, the control commands of the memory management circuit 51 may be implemented in a hardware form. For example, the memory management circuit 51 includes a microprocessor, a memory cell management circuit, a memory writing circuit, a memory reading circuit, a memory erasing circuit, and a data processing circuit. The memory cell management circuit, the memory writing circuit, the memory reading circuit, the memory erasing circuit, and the data processing circuit are coupled to the microprocessor. The memory cell management circuit is configured to manage the memory cells or the memory cell groups of the rewritable non-volatile memory module 43. The memory writing circuit is configured to issue a write command sequence to the rewritable non-volatile memory module 43 so as to write data into the rewritable non-volatile memory module 43. The memory reading circuit is configured to issue a read command sequence to the rewritable non-volatile memory module 43 so as to read data from the rewritable non-volatile memory module 43. The memory erasing circuit is configured to issue an erase command sequence to the rewritable non-volatile memory module 43 so as to erase data from the rewritable non-volatile memory module 43. The data processing circuit is configured to process data to be written into the rewritable non-volatile memory module 43 and data to be read from the rewritable non-volatile memory module 43. Each of the write command sequence, the read command sequence, and the erase command sequence may include one or more program codes or command codes and is configured to instruct the rewritable non-volatile memory module 43 to execute corresponding data operations such as data writing, data reading, and data erasing. In an exemplary embodiment, the memory management circuit 51 may further issue other types of command sequences to the rewritable non-volatile memory module 43 to instruct the execution of corresponding operations.

The host interface 52 is coupled to the memory management circuit 51. The memory management circuit 51 may communicate with the host system 11 through the host interface 52. The host interface 52 may be configured to obtain and identify commands and data of the host system 11. For instance, the commands and the data of the host system 11 may be transmitted to the memory management circuit 51 through the host interface 52. Besides, the memory management circuit 51 may transmit data to the host system 11 through the host interface 52. In this exemplary embodiment, the host interface 52 is compatible with the PCI Express standard. However, it should be understood that the disclosure is not limited thereto, and the host interface 52 may also be compatible to the SATA standard, the PATA standard, the IEEE 1394 standard, the USB standard, the SD standard, the UHS-I standard, the UHS-II standard, the MS standard, the MMC standard, the eMMC standard, the UFS standard, the CF standard, the IDE standard, or other applicable standards for data transmission.

The memory interface 53 is coupled to the memory management circuit 51 and is configured to access the rewritable non-volatile memory module 43. For instance, the memory management circuit 51 may access the rewritable non-volatile memory module 43 through the memory interface 53. In other words, data to be written to the rewritable non-volatile memory module 43 is converted into the format acceptable to the rewritable non-volatile memory module 43 through the memory interface 53. Specifically, when the memory management circuit 51 is to access the rewritable non-volatile memory module 43, the memory interface 53 sends the corresponding command sequences. For instance, the command sequences may include a write command sequence instructing data-writing, a read command sequence instructing data-reading, an erase command sequence instructing data-erasing, and corresponding command sequences configured for instructing various memory operations (e.g., changing reading voltage levels or executing garbage collection (GC), etc.). The command sequences are generated by, for example, the memory management circuit 51, and are sent to the rewritable non-volatile memory module 43 through the memory interface 53. These command sequences may include one or more signals or data on the bus. These signals or data may include command codes or program codes. For example, the read command sequence may include information such as identification codes and memory addresses.

In an exemplary embodiment, the memory control circuit unit 42 further includes an error detecting and correcting circuit 54, a buffer memory 55, and a power management circuit 56.

The error detecting and correcting circuit 54 is coupled to the memory management circuit 51 and is configured to execute an error detecting and correcting operation to ensure the correctness of data. To be specific, when the memory management circuit 51 obtains a write command from the host system 11, the error detecting and correcting circuit 54 generates a corresponding error correcting code (ECC) and/or an error detecting code (EDC) for the data corresponding to the write command, and the memory management circuit 51 writes the data corresponding to the write command and the corresponding error correcting code and/or the error detecting code to the rewritable non-volatile memory module 43. Afterwards, when the memory management circuit 51 reads the data from the rewritable non-volatile memory module 43, the corresponding error correcting code and/or the error detecting code is simultaneously read, and the error detecting and correcting circuit 54 executes error detecting and correcting operations for the read data based on the error correcting code and/or the error detecting code.

The buffer memory 55 is coupled to the memory management circuit 51 and is used to temporarily store data. The power management circuit 56 is coupled to the memory management circuit 51 and is configured to control power of the memory storage device 10.

In an exemplary embodiment, the rewritable non-volatile memory module 43 of FIG. 4 may include a flash memory module. In an exemplary embodiment, the memory control circuit unit 42 of FIG. 4 may include a flash memory controller. In an exemplary embodiment, the memory management circuit 51 of FIG. 5 may include a flash memory management circuit.

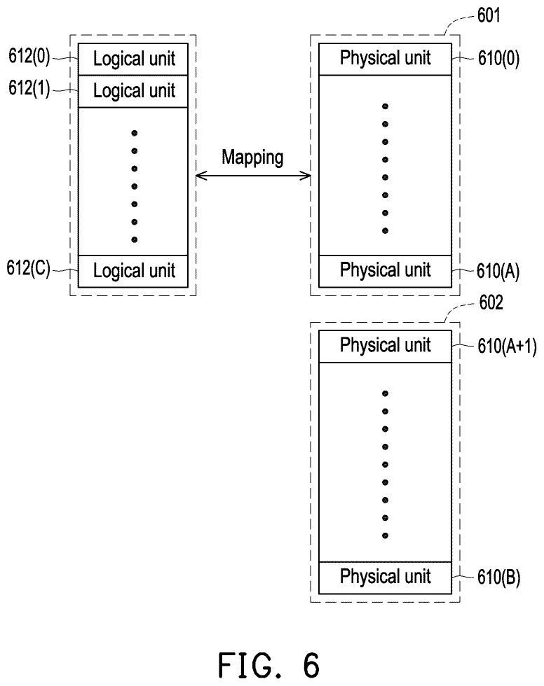

FIG. 6 is a schematic view illustrating management of a rewritable non-volatile memory module according to an exemplary embodiment of the disclosure. With reference to FIG. 6, the memory management circuit 51 logically group physical units 610(0) to 610(B) in the rewritable non-volatile memory module 43 into a storage region 601 and a spare region 602.

In an exemplary embodiment, one physical unit refers to one physical address or one physical programming unit. In an exemplary embodiment, one physical unit may also be composed of a plurality of consecutive or inconsecutive physical addresses. In an exemplary embodiment, one physical unit may also refer to one virtual block (VB). One virtual block may include a plurality of physical addresses or a plurality of physical programming units. In an exemplary embodiment, one virtual block may include one or more physical erasing units

The physical units 610(0) to 610(A) in the storage region 601 are configured to store user data (e.g., the user data from the host system 11 in FIG. 1). For instance, the physical units 610(0) to 610(A) in the storage region 601 may be stored with valid data and invalid data. The physical units 610(A+1) to 610(B) in the spare region 602 do not store data (e.g., valid data). For instance, if one physical unit does not store valid data, then this physical unit may be associated with (or added to) the spare region 602. Moreover, the physical units in the spare region 602 (or physical units not storing valid data) may be erased. When writing new data, one or more physical units may be extracted from the spare region 602 to store this new data. In an exemplary embodiment, the spare region 602 is also known as a free pool.

The memory management circuit 51 may allocate logical units 612(0) to 612(C) to be mapped to the physical units 610(0) to 610(A) in the storage region 601. In an exemplary embodiment, one logical unit corresponds to one logical address. For example, one logical address may include one or a plurality of logical block addresses (LBAs) or other logical management units. In an exemplary embodiment, one logical unit may also correspond to one logical programming unit or be composed of a plurality of consecutive or inconsecutive logical addresses.

It should be noted that one logical unit may be mapped to one or more physical units. If one physical unit is currently mapped by a logical unit, it indicates that the data currently stored in this physical unit includes valid data. In contrast, if one physical unit is not currently mapped by a logical unit, it indicates that the data currently stored in this physical unit is invalid data.

The memory management circuit 51 may record management data (also referred to logical-to-physical mapping information) described the mapping relationship between the logical units and the physical units to at least one logical-to-physical mapping table. When the host system 11 wishes to read data from the memory storage device 10 or write data to the memory storage device 10, the memory management circuit 51 may access the rewritable non-volatile memory module 43 based on information in this logical-to-physical mapping table.

In an exemplary embodiment, the memory storage device 10 supports error handling, where data is first encoded by the error detecting and correcting circuit 54 before being stored in the rewritable non-volatile memory module 43. When reading a physical unit (also referred to as a target physical unit), the memory management circuit 51 executes an initial read operation, which may first use a preset (or previously used) read voltage level to read the memory cells in the target physical unit to obtain the verification bits (e.g., bit 0 or bit 1) of the memory cells. The error detecting and correcting circuit 54 executes a decoding operation based on these verification bits of the memory cells to generate a plurality of decoded bits. These decoded bits may form decoded data (i.e., a codeword). In an exemplary embodiment, if the error detecting and correcting circuit 54 cannot successfully decode, the error detecting and correcting circuit 54 responds with a decoding failure (i.e., too many error bits stored in the memory cells), and the memory management circuit 51 executes an error handling process.

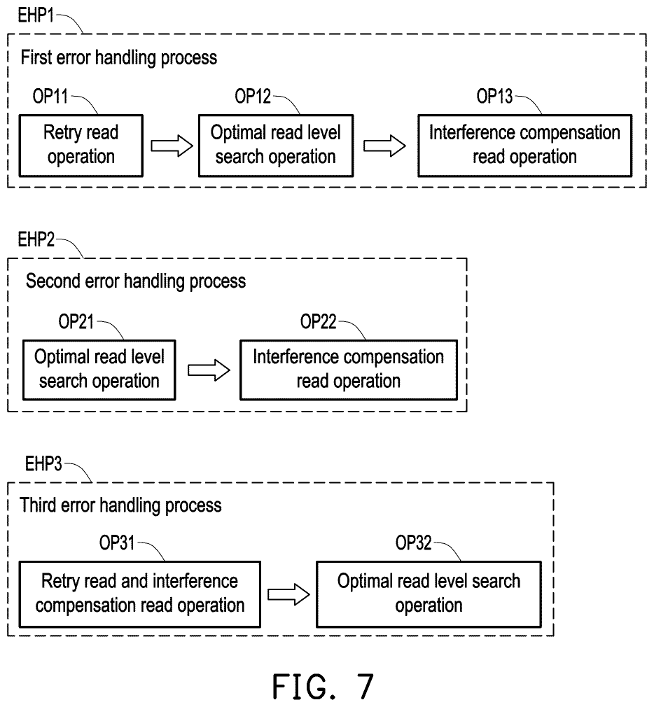

FIG. 7 is a schematic view illustrating different types of error handling processes according to an exemplary embodiment of the disclosure. With reference to FIG. 7, the memory storage device 10 may support, for example, a first error handling process EHP1, a second error handling process EHP2, and a third error handling process EHP3 as shown in FIG. 7. When the error detecting and correcting circuit 54 cannot successfully decode, the memory management circuit 51 may perform the first error handling process EHP1, the second error handling process EHP2, or the third error handling process EHP3.

In an exemplary embodiment, the memory management circuit 51 may determine the error handling process to be performed based on a decoding rate. In an exemplary embodiment, the memory management circuit 51 may determine the error handling process to be performed based on health status information of the rewritable non-volatile memory module 43. In an exemplary embodiment, the memory management circuit 51 may determine the error handling process to be performed based on a command from the host system 11. In an exemplary embodiment, the memory management circuit 51 may determine the error handling process to be performed based on actual usage conditions.

In an exemplary embodiment, the first error handling process EHP1 includes a plurality of decoding operations performed based on a first order. The first error handling process EHP1 may include, but is not limited to, a retry read operation OP11, an optimal read level search operation OP12, and an interference compensation read operation OP13 performed according to the first order. In an exemplary embodiment, the second error handling process EHP2 includes a plurality of decoding operations performed based on a second order. The second error handling process EHP2 may include, but is not limited to, an optimal read level search operation OP21 and an interference compensation read operation OP22 performed according to the second order. In an exemplary embodiment, the third error handling process EHP3 includes a plurality of decoding operations performed based on a third order. The third error handling process EHP3 may include, but is not limited to, a retry read and interference compensation read operation OP31 and an optimal read level search operation OP32 performed according to the third order.

In an exemplary embodiment, at least one decoding operation among the decoding operations included in the first error handling process EHP1 is the same as at least one decoding operation among the decoding operations included in the second error handling process EHP2. For instance, both the first error handling process EHP1 and the second error handling process EHP2 include the same optimal read level search operations OP12 and OP21 and interference compensation read operations OP13 and OP22. In an exemplary embodiment, the at least one decoding operation among the decoding operations included in the first error handling process EHP1, the at least one decoding operation among the decoding operations included in the second error handling process EHP2, and at least one decoding operation among the decoding operations included in the third error handling process EHP3 are the same. For instance, the first error handling process EHP1, the second error handling process EHP2, and the third error handling process EHP3 all include the optimal read level search operations OP12, OP21, and OP32.

In an exemplary embodiment, when the memory management circuit 51 performs the first error handling process EHP1 (or the second error handling process EHP2 or the third error handling process EHP3), if one of the decoding operations in the first error handling process EHP1 (or the second error handling process EHP2 or the third error handling process EHP3) is successful and a codeword is obtained, the memory management circuit 51 may end the first error handling process EHP1 (or the second error handling process EHP2 or the third error handling process EHP3). If all of the decoding operations in the first error handling process EHP1 (or the second error handling process EHP2 or the third error handling process EHP3) fail, the memory management circuit 51 obtains a result that cannot be decoded and end the first error handling process EHP1 (or the second error handling process EHP2 or the third error handling process EHP3).

In an exemplary embodiment, the retry read operation OP11 may be, for example, performed by the memory management circuit 51 to re-obtain another read voltage level to read the memory cells of the target physical unit, so as to re-obtain the verification bits of the memory cells, and the error detecting and correcting circuit 54 performs the abovementioned decoding operations according to the retrieved verification bits. When there are too many error bits, by adopting another read voltage level to re-obtain the verification bits, it may change the verification bits of some memory cells in the target physical unit, providing an opportunity to change the decoding result of the decoding operation.

In an exemplary embodiment, the optimal read level search operations OP12, OP21, and OP32 may be, for example, performed by the memory management circuit 51 to re-obtain a read voltage level different from the previous read voltage level to read the memory cells of the target physical unit, so as to re-obtain the verification bits of the memory cells. The error detecting and correcting circuit 54 performs the above decoding operations according to the re-obtained multiple verification bits to obtain another data composed of multiple decoded bits. If the decoding fails again (i.e., the error bits of the re-obtained verification bits are too many), the memory management circuit 51 re-obtains another read voltage level to try decoding again until the decoding is successful or the preset number of decoding attempts is exceeded.

In an exemplary embodiment, the interference compensation read operations OP13 and OP22 may be, for example, performed by the memory management circuit 51 while re-reading the memory cells of the target physical unit, also reading the memory cells of the neighboring physical units that may cause interference to the target physical unit, so as to perform the abovementioned decoding operations by using the verification bits obtained from the memory cells of the target physical unit and the verification bits obtained from the memory cells of the neighboring physical units to improve the success rate of the decoding operations.

In an exemplary embodiment, the retry read and interference compensation read operation OP31, as its name suggests, is a combination of the retry read operation OP11 and the interference compensation read operations OP13 and OP22. The retry read and interference compensation read operation OP31 may be, for example, performed by the memory management circuit 51 to reacquire another read voltage level to read the target physical unit and read the memory cells of the neighboring physical units that may interfere with the target physical unit, so as to obtain multiple verification bits of the target physical unit and the neighboring physical units and perform the abovementioned decoding operations accordingly, so as to improve the success rate of the decoding operations. In another exemplary embodiment, when adjusting the error handling process, during the initial read operation on the target physical unit, the interference compensation read operations OP13 and OP22 may also be performed, which means combining the initial read operation with the interference compensation read operations OP13 and OP22.

In an exemplary embodiment, the first error handling process EHP1 includes a first number (e.g., 3) of decoding operations, and the second error handling process EHP2 includes a second number (e.g., 2) of decoding operations. The first number is greater than the second number. In an exemplary embodiment, the first error handling process EHP1 includes the first number (e.g., 3) of decoding operations, and the third error handling process EHP3 includes a third number (e.g., 2) of decoding operations. The first number is greater than the third number.

In an exemplary embodiment, a decoding capability of the first decoding operation indicated by the second order (i.e., the optimal read level search operation OP21) is better than a decoding capability of the first decoding operation indicated by the first order (i.e., the retry read operation OP11). Better decoding capability indicates a higher probability of successful decoding. In an exemplary embodiment, a decoding capability of the first decoding operation indicated by the third order (i.e., the retry read and interference compensation read operation OP31) is better than the decoding capability of the first decoding operation indicated by the second order.

In an exemplary embodiment, the first error handling process EHP1 is the preset error handling process. In other words, the memory storage device 10 by default adopts the first error handling process EHP1. The first error handling process EHP1 includes a plurality of operations executed based on the first order, where the first order may indicate the decoding capability (or operation time) of these operations. For instance, the memory management circuit 51 may, according to the first order, first perform operations with weaker decoding capability and then sequentially perform other operations according to their decoding capabilities. For instance, the memory management circuit 51 may, according to the first order, first perform operations with shorter operation time and then sequentially perform other operations according to their operation time.

In other words, the decoding capability of the retry read operation OP11 is lower than the decoding capability of the optimal read level search operation OP12, and the decoding capability of the optimal read level search operation OP12 is lower than the decoding capability of the interference compensation read operation OP13. In other words, the operation time of the retry read operation OP11 is less than the operation time of the optimal read level search operation OP12, and the operation time of the optimal read level search operation OP12 is less than the operation time of the interference compensation read operation OP13.

In an exemplary embodiment, the memory management circuit 51 may calculate a first decoding rate of the first error handling process EHP1. For instance, the memory management circuit 51 may periodically calculate the first decoding rate of the first error handling process EHP1. For instance, at each time interval, the memory management circuit 51 may calculate the first decoding rate of the first error handling process EHP1. For instance, after the rewritable non-volatile memory module 43 receives a certain number of read command sequences, the memory management circuit 51 may calculate the first decoding rate of the first error handling process EHP1. For instance, the memory management circuit 51 may set a read count value, and when this read count value reaches a count threshold, the memory management circuit 51 may calculate the first decoding rate of the first error handling process EHP1 and reset this read count value. In an exemplary embodiment, the first decoding rate is the success rate of the first decoding operation (i.e., the retry read operation OP11) indicated by the first order.

In an exemplary embodiment, when the first decoding rate is less than a first threshold, the memory management circuit 51 may switch the first error handling process EHP1 to the second error handling process EHP2. Specifically, the first decoding rate being less than the first threshold indicates that the decoding capability of the retry read operation OP11 is insufficient. Therefore, the memory management circuit 51 may switch the first error handling process EHP1 to the second error handling process EHP2, which has a relatively stronger decoding capability for its first decoding operation (i.e., the optimal read level search operation OP21), to reduce decoding time.

In an exemplary embodiment, the memory management circuit 51 may calculate a second decoding rate of the second error handling process EHP2. For instance, the memory management circuit 51 may periodically calculate the second decoding rate of the second error handling process EHP2. For instance, at each time interval, the memory management circuit 51 may calculate the second decoding rate of the second error handling process EHP2. For instance, after the rewritable non-volatile memory module 43 receives a certain number of read command sequences, the memory management circuit 51 may calculate the second decoding rate of the second error handling process EHP2. For instance, the memory management circuit 51 may set a read count value, and when this read count value reaches a count threshold, the memory management circuit 51 may calculate the second decoding rate of the second error handling process EHP2 and reset this read count value. In an exemplary embodiment, the second decoding rate is the success rate of each of the decoding operations (i.e., the optimal read level search operation OP21 and the interference compensation read operation OP22) in the second error handling process EHP2. In another exemplary embodiment, the second decoding rate is the success rate of the first decoding operation (i.e., the optimal read level search operation OP21) indicated by the second order.

In an exemplary embodiment, when the second decoding rate is not less than a second threshold, the memory management circuit 51 may switch the second error handling process EHP2 to the first error handling process EHP1. That is, when the success rate of the optimal read level search operation OP21 and/or the success rate of the interference compensation read operation OP22 is not less than the second threshold, the memory management circuit 51 may restore the second error handling process EHP2 to the preset first error handling process EHP1. Specifically, the second decoding rate being not less than the second threshold indicates a high success rate of reading the target physical unit from the rewritable non-volatile memory module 43. Therefore, the memory management circuit 51 may restore the second error handling process EHP2 to the first error handling process EHP1, which has a relatively shorter operation time for its first decoding operation (i.e., the retry read operation OP11), to reduce decoding time.

In an exemplary embodiment, when the second decoding rate is less than a third threshold, the memory management circuit 51 may switch the second error handling process EHP2 to the third error handling process EHP3. Specifically, the second decoding rate being less than the third threshold indicates that the decoding capabilities of the optimal read level search operation OP21 and the interference compensation operation OP22 is insufficient. Therefore, the memory management circuit 51 may switch the second error handling process EHP2 to the third error handling process EHP3, which has a relatively stronger decoding capability for its first decoding operation (i.e., the retry read and interference compensation read operation OP31), to reduce decoding time.

In an exemplary embodiment, the memory management circuit 51 may calculate a third decoding rate of the third error handling process EHP3. Regarding the implementation details of calculating the third decoding rate, reference may be made to the aforementioned methods for calculating the first decoding rate and the second decoding rate, so description thereof is not be repeated herein. In an exemplary embodiment, the third decoding rate is the success rate of each decoding operation in the third error handling process EHP3 (i.e., the retry read and interference compensation read operation OP31 and the optimal read level search operation OP32). In another exemplary embodiment, the third decoding rate is the success rate of the first decoding operation (i.e., the retry read and interference compensation read operation OP31) indicated by the third sequence.

In an exemplary embodiment, when the third decoding rate is not less than a fourth threshold, the memory management circuit 51 may switch the third error handling process EHP3 to the second error handling process EHP2 (or the first error handling process EHP1). That is, when the success rate of the retry read and interference compensation read operation OP31 and/or the success rate of the optimal read level search operation OP32 is not less than the fourth threshold, the memory management circuit 51 may switch the third error handling process EHP3 to the second error handling process EHP2 (or the first error handling process EHP1) with a relatively shorter operation time for its first decoding operation (i.e., the optimal read level search operation OP21 or the retry read operation OP11), to reduce decoding time. In another exemplary embodiment, a fourth decoding rate of the initial read operation may also be calculated, and the implementation details of calculating the fourth decoding rate may refer to the aforementioned methods for calculating the first decoding rate and the second decoding rate, so description thereof is not repeated herein. In an exemplary embodiment, the fourth decoding rate is the success rate of multiple initial read operations, where each read command sequence has one initial read operation. The memory management circuit 51 may switch the error handling process according to the fourth decoding rate. For instance, when the fourth decoding rate is lower, it may switch to an error handling process with a relatively stronger decoding capability. Conversely, when the fourth decoding rate is higher, it may switch to an error handling process with a relatively weaker decoding capability. The implementation details of switching the error handling process may refer to the aforementioned methods, so description thereof is not repeated herein.

In an exemplary embodiment, the memory management circuit 51 may obtain health status information of the rewritable non-volatile memory module 43. The health status information may include, but is not limited to, at least one of the temperature, read count, erase count, write count, fourth decoding rate, and error bit count of the rewritable non-volatile memory module 43. Next, the memory management circuit 51 may adopt the first error handling process EHP1, the second error handling process EHP2, or the third error handling process EHP3 according to the health status information. For instance, the memory management circuit 51 may determine that the rewritable non-volatile memory module 43 is in good condition based on the health status information and accordingly adopt the first error handling process EHP1. For instance, the memory management circuit 51 may determine that the rewritable non-volatile memory module 43 is in moderate condition based on the health status information and accordingly adopt the second error handling process EHP2. For instance, the memory management circuit 51 may determine that the rewritable non-volatile memory module 43 is in poor condition based on the health status information and accordingly adopt the third error handling process EHP3.

According to the above, the memory management circuit 51 may select an appropriate error handling process based on the health status information to improve the performance of the memory storage device 10.

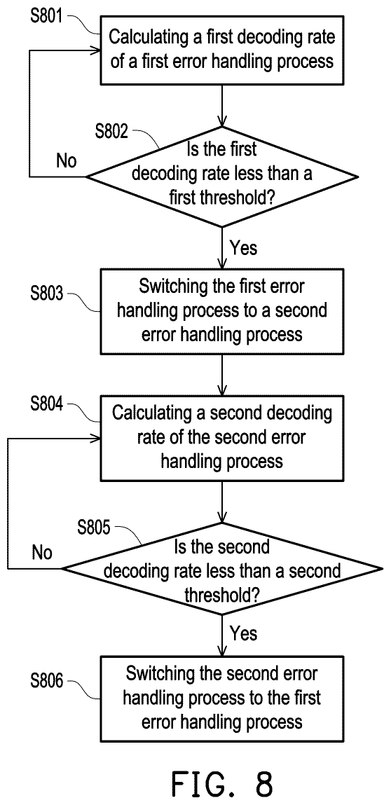

FIG. 8 is a flow chart illustrating an error handling method according to an exemplary embodiment of the disclosure. With reference to FIG. 8, in step S801, the first decoding rate of the first error handling process EHP1 is calculated. In step S802, it is determined whether the first decoding rate is less than the first threshold. If the first decoding rate is not less than the first threshold, the process returns to step S801. If the first decoding rate is less than the first threshold, the process proceeds to execute step S803. In step S803, the first error handling process EHP1 is switched to the second error handling process EHP2. In step S804, the second decoding rate of the second error handling process EHP2 is calculated. In step S805, it is determined whether the second decoding rate is not less than the second threshold. If the second decoding rate is less than the second threshold, the process returns to step S804. If the second decoding rate is not less than the second threshold, the process proceeds to execute step S806. In step S806, the second error handling process EHP2 is switched to the first error handling process EHP1. After executing step S806, the process may return to step S801 to re-execute the error handling method of FIG. 8.

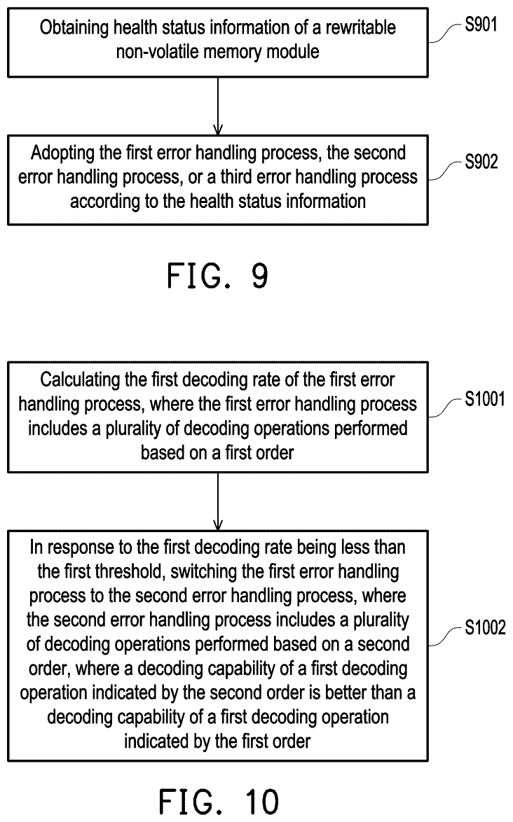

FIG. 9 is a flow chart illustrating an error handling method according to an exemplary embodiment of the disclosure. With reference to FIG. 9, in step S901, the health status information of the rewritable non-volatile memory module 43 is obtained. In step S902, based on the health status information, the first error handling process EHP1, the second error handling process EHP2, or the third error handling process EHP3 is adopted.

FIG. 10 is a flow chart illustrating an error handling method according to an exemplary embodiment of the disclosure. With reference to FIG. 10, in step S1001, the first decoding rate of the first error handling process EHP1 is calculated, where the first error handling process EHP1 includes multiple decoding operations performed based on the first order. In step S1002, in response to the first decoding rate being less than the first threshold, the first error handling process EHP1 is switched to the second error handling process EHP2. The second error handling process EHP2 includes multiple decoding operations performed based on the second order, and the decoding capability of the first decoding operation indicated by the second order is better than the decoding capability of the first decoding operation indicated by the first order.

Regarding the steps in FIG. 8 to FIG. 10, description thereof has been provided in detail in the foregoing paragraphs and thus is not repeated herein. It is worth noting that the steps in FIG. 8 to FIG. 10 may be implemented as multiple codes or circuits, which is not limited by the disclosure. In addition, the methods of FIG. 8 to FIG. 10 may be used in combination with the above exemplary embodiments or may be used independently, which is not limited by the disclosure.

In view of the foregoing, in the error handling method, the memory storage device, and the memory control circuit unit provided by the embodiments of the disclosure, a plurality of different error handling processes are provided. Further, an appropriate error handling process may be selected based on the decoding rate of the current error handling process or the health status information of the rewritable non-volatile memory module. In this way, the average decoding time is reduced, and the performance of the memory storage device is improved.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An error handling method for a rewritable non-volatile memory module, the error handling method comprising:
calculating a first decoding rate of a first error handling process, wherein the first error handling process comprises a plurality of decoding operations performed based on a first order; and
in response to the first decoding rate being less than a first threshold, switching the first error handling process to a second error handling process, wherein the second error handling process comprises a plurality of decoding operations performed based on a second order,
wherein a decoding capability of a first decoding operation indicated by the second order is better than a decoding capability of a first decoding operation indicated by the first order.

2. The error handling method according to claim 1, further comprising:
calculating a second decoding rate of the second error handling process; and
in response to the second decoding rate being not less than a second threshold, switching the second error handling process to the first error handling process.

3. The error handling method according to claim 1, wherein the first decoding rate is a success rate of the first decoding operation indicated by the first order.

4. The error handling method according to claim 2, wherein the second decoding rate is a success rate of each of the decoding operations in the second error handling process.

5. The error handling method according to claim 1, wherein the first error handling process comprises a first number of decoding operations, and the second error handling process comprises a second number of decoding operations, wherein the first number is greater than the second number.

6. The error handling method according to claim 1, further comprising:
obtaining health status information of the rewritable non-volatile memory module; and
adopting one of the first error handling process, the second error handling process, and a third error handling process according to the health status information.

7. The error handling method according to claim 6, wherein the third error handling process comprises a plurality of decoding operations performed based on a third order, and a decoding capability of a first decoding operation indicated by the third order is better than the decoding capability of the first decoding operation indicated by the second order.

8. A memory storage device, comprising:
a connection interface unit configured to be coupled to a host system;
a rewritable non-volatile memory module; and
a memory control circuit unit coupled to the connection interface unit and the rewritable non-volatile memory module,
wherein the memory control circuit unit is configured to:
calculate a first decoding rate of a first error handling process, wherein the first error handling process comprises a plurality of decoding operations performed based on a first order, and
in response to the first decoding rate being less than a first threshold, switch the first error handling process to a second error handling process, wherein the second error handling process comprises a plurality of decoding operations performed based on a second order,
wherein a decoding capability of a first decoding operation indicated by the second order is better than a decoding capability of a first decoding operation indicated by the first order.

9. The memory storage device according to claim 8, wherein the memory control circuit unit is further configured to:
calculate a second decoding rate of the second error handling process, and
in response to the second decoding rate being not less than a second threshold, switch the second error handling process to the first error handling process.

10. The memory storage device according to claim 8, wherein the first decoding rate is a success rate of the first decoding operation indicated by the first order.

11. The memory storage device according to claim 9, wherein the second decoding rate is a success rate of each of the decoding operations in the second error handling process.

12. The memory storage device according to claim 8, wherein the first error handling process comprises a first number of decoding operations, and the second error handling process comprises a second number of decoding operations, wherein the first number is greater than the second number.

13. The memory storage device according to claim 8, wherein the memory control circuit unit is further configured to:
obtain health status information of the rewritable non-volatile memory module, and
adopt one of the first error handling process, the second error handling process, and a third error handling process according to the health status information.

14. The memory storage device according to claim 13, wherein the third error handling process comprises a plurality of decoding operations performed based on a third order, and a decoding capability of a first decoding operation indicated by the third order is better than the decoding capability of the first decoding operation indicated by the second order.

15. A memory control circuit unit configured to control a rewritable non-volatile memory module, the memory control circuit unit comprising:
a host interface configured to be coupled to a connection interface unit;
a memory interface configured to be coupled to the rewritable non-volatile memory module; and
a memory management circuit coupled to the host interface and the memory interface,
wherein the memory management circuit is configured to:
calculate a first decoding rate of a first error handling process, wherein the first error handling process comprises a plurality of decoding operations performed based on a first order, and
in response to the first decoding rate being less than a first threshold, switch the first error handling process to a second error handling process, wherein the second error handling process comprises a plurality of decoding operations performed based on a second order,
wherein a decoding capability of a first decoding operation indicated by the second order is better than a decoding capability of a first decoding operation indicated by the first order.

16. The memory control circuit unit according to claim 15, wherein the memory management circuit is further configured to:
calculate a second decoding rate of the second error handling process, and
in response to the second decoding rate being not less than a second threshold, switch the second error handling process to the first error handling process.

17. The memory control circuit unit according to claim 15, wherein the first decoding rate is a success rate of the first decoding operation indicated by the first order.

18. The memory control circuit unit according to claim 16, wherein the second decoding rate is a success rate of each of the decoding operations in the second error handling process.

19. The memory control circuit unit according to claim 15, wherein the first error handling process comprises a first number of decoding operations, and the second error handling process comprises a second number of decoding operations, wherein the first number is greater than the second number.

20. The memory control circuit unit according to claim 15, wherein the memory management circuit is further configured to:
obtain health status information of the rewritable non-volatile memory module, and
adopt one of the first error handling process, the second error handling process, and a third error handling process according to the health status information.

21. The memory control circuit unit according to claim 20, wherein the third error handling process comprises a plurality of decoding operations performed based on a third order, and a decoding capability of a first decoding operation indicated by the third order is better than the decoding capability of the first decoding operation indicated by the second order.

22. A memory storage device, comprising:
a connection interface unit configured to be coupled to a host system;
a rewritable non-volatile memory module; and
a memory control circuit unit coupled to the connection interface unit and the rewritable non-volatile memory module,
wherein the memory control circuit unit is configured to:
perform a first error handling process or a second error handling process,
wherein the first error handling process comprises a plurality of decoding operations performed based on a first order, and the first error handling process comprises a first number of decoding operations,
wherein the second error handling process comprises a plurality of decoding operations performed based on a second order, and the second error handling process comprises a second number of decoding operations,
wherein at least one decoding operation among the decoding operations comprised in the first error handling process is the same as at least one decoding operation among the decoding operations comprised in the second error handling process,
wherein a decoding capability of a first decoding operation indicated by the second order is better than a decoding capability of a first decoding operation indicated by the first order, and the first number is greater than the second number.

23. The memory storage device according to claim 22, wherein the memory control circuit unit is further configured to:
perform one of the first error handling process, the second error handling process, and a third error handling process,
wherein the third error handling process comprises a plurality of decoding operations performed based on a third order, and a decoding capability of a first decoding operation indicated by the third order is better than the decoding capability of the first decoding operation indicated by the second order.

24. The memory storage device according to claim 23, wherein
the at least one decoding operation among the decoding operations comprised in the first error handling process, the as at least one decoding operation among the decoding operations comprised in the second error handling process, and at least one decoding operation among the decoding operations comprised in the third error handling process are the same.

25. A memory control circuit unit configured to control a rewritable non-volatile memory module, the memory control circuit unit comprising:
a host interface configured to be coupled to a connection interface unit;
a memory interface configured to be coupled to the rewritable non-volatile memory module; and
a memory management circuit coupled to the host interface and the memory interface,
wherein the memory management circuit is configured to:
perform a first error handling process or a second error handling process,
wherein the first error handling process comprises a plurality of decoding operations performed based on a first order, and the first error handling process comprises a first number of decoding operations,
wherein the second error handling process comprises a plurality of decoding operations performed based on a second order, and the second error handling process comprises a second number of decoding operations,
wherein at least one decoding operation among the decoding operations comprised in the first error handling process is the same as at least one decoding operation among the decoding operations comprised in the second error handling process,
wherein a decoding capability of a first decoding operation indicated by the second order is better than a decoding capability of a first decoding operation indicated by the first order, and the first number is greater than the second number.

26. The memory control circuit unit according to claim 25, wherein the memory management circuit is further configured to:
perform one of the first error handling process, the second error handling process, and a third error handling process,
wherein the third error handling process comprises a plurality of decoding operations performed based on a third order, and a decoding capability of a first decoding operation indicated by the third order is better than the decoding capability of the first decoding operation indicated by the second order.

27. The memory control circuit unit according to claim 26, wherein
the at least one decoding operation among the decoding operations comprised in the first error handling process, the as at least one decoding operation among the decoding operations comprised in the second error handling process, and at least one decoding operation among the decoding operations comprised in the third error handling process are the same.
